(19) United States
(12) Patent Application Publication
(10) Pub. No.: US 2025/0230611 A1
(43) Pub. Date: Jul. 17, 2025

(54) TRACK

(71) Applicant: TDI GREENWAY TECHNOLOGIES LTD., Warwickshire (GB)

(72) Inventors: Adrian Howson, Warwickshire (GB); Ollie Godwin, Warwickshire (GB); Lyle Swan, Warwickshire (GB)

(21) Appl. No.: 18/853,031

(22) PCT Filed: Mar. 31, 2023
(86) PCT No.: PCT/GB2023/050878

§ 371 Date: Sep. 30, 2024

(30) Foreign Application Priority Data
Mar. 31, 2022 (GB) 2204742.7

(51) Int. Cl. E01B 1/00; B60L 53/122; B61L 23/04; E01B 9/28; E01B 26/00; H02J 50/10

(52) U.S. Cl. CPC E01B 1/007; B60L 53/122; B61L 23/048; E01B 1/008; E01B 9/28; E01B 26/00; B60L 2200/26; E01B 2204/06; E01B 2204/07; E01B 2204/09; E01B 2204/14; H02J 50/10

(57) ABSTRACT

Track and more particularly slabs (1) for a light railway track in which the slab comprises a convex end (2) and a concave end (3) which are generally concentric and reciprocal to each other such that in use the convex end of one slab and engage the concave end of another slab with the respective slabs at an angle to each other. The slabs are secured together to provided straight and curved sections with a modular slab shape and allowing other features for monitoring and/or improved operation.

The present invention relates to track and more particularly but not exclusively to light railway or trams used in urban environments.

The use of sleepers and slabs with attached rails is well known in order to spread load and for more convenient installation. The slabs have a typical 6 metres by 2 metres by 0.2 metre depth. These are easier to lay and by reason of the broad area mean there is less disruption of the surface about the rails. The surface may be a roadway for motor vehicles and use of slabs will reduce the requirements for foundations. Furthermore, the use of slabs can achieve a more robust, resilient and stronger installation where there is sharing with other road users and with urban environments there will be buried utility services such electricity, gas, water, sewage and communications cables some of which might require surveying prior to installation. Slabs also allow a degree of modular construction rendering installation more efficient and allowing some of off site preparation of facilities reducing installation time on site. Modular slabs allow provision of services, monitoring and maintenance potentially easier.

As will be appreciated one problem with slabs is at corners which inevitably are variable and present in urban locations due to pre-existing street and road layout. These require special considerations including almost bespoke manufacture of the slab/rail sections or use of inserts to accommodate the curves. These approaches are cumbersome and time consuming.

In accordance with first aspects of the present invention there is provided a track comprising a plurality of slab elements with a least one rail extending over those slabs, the slabs having opposed convex end and concave end in respective ends for an inter-engaging of adjacent slabs whereby the slab elements are configured to be positioned substantially in the plane of the inter-engaging convex end and concave end and whereby the longitudinal axis of each slab need not be parallel with adjacent slabs.

Also in accordance with some aspects of the present invention there is provided a track slab for rails, the slab comprising an elongate element with a convex end and a concave end to allow articulation thereabout. The convex end and the concave end being reciprocally shaped for inter-engaging with adjacent slabs in use.

Also in accordance with second aspects of the present invention is provided a slab for rails in which the slab includes at least one optical fibre and preferably at least 3 optical fibres arrange to allow coupling with other optical fibres. The optical fibres may be aligned along the major longitudinal axis of the slab and/or substantially centrally across the width of the slab. Typically, different sensor frequencies can be passed along the optical fibres. Preferably, a sensor can determine specific vibration signature frequencies indicative of particular rail events such as cracking in slab, vehicle transit and movements. Optical fibre sensing may be used and coupled to allow coordination with road traffic signals.

Also in accordance with third aspects of the present invention is provided a slab with a slot lateral from an edge and arranged to receive a clip such that the clip for a rail can be positioned along the slot. The clip may include means to fix the clip within the slot. The means to fix the clip includes a bolt to allow positioning the clip to be positioned in the X and Y direction. The bolt may have a T-nut head. The slot may be reinforced with an embedded steel insert. The slot lateral may allow lateral adjustment of the position of the rails as desired for rail width adjustment and maintenance.

Also in accordance with fourth aspects of the present invention is provided a slab with a longitudinal recess along the slab configured to provide accommodation for transit of utility service and other conduits. Typically, a U-shaped channel member will be arranged to be located below the longitudinal recess. The channel member and the slab typically about the side edges of the recess will have means for retention of location. The means for retention of location may provide a fixing such as pegs or bolts or adhesive.

Also in accordance with fifth aspects of the present invention there is provided a slab formed with fibres for reinforcement. The fibres may be formed or provided by for example polypropylene sticks or fibres of a metallic, glass, polymer or synthetic nature. Typically, in accordance with some aspects of the present invention slabs may be provided in a plurality of lengths whereby a range of curves in conjoined slabs can be achieved.

Further in accordance with sixth aspects of the present invention there is provided a slab for rail where there is provided charging loops embedded within the slab. The charging loops may be copper coils. The charging loops may be configured to magnetically couple with reciprocal loops in a train arranged to pass or located over the charging loops.

Also in accordance with seventh aspects of the present invention there is provided a slab with lip or shelf or ledge element convex and concave ends to align the slab with other slabs in use. Typically, the lip or shelf or ledge elements overlap in use with other slab lip or shelf or ledge element ends in use. Possibly any gap between lip or shelf or ledge finger ends in adjacent slabs in use is filled with a filler. The filler is typically an elastomer. The lip or shelf or ledge element ends lap one on top of the other. Alternatively, the respective convex and concave ends include tongues and grooves to engage each other in use.

Generally, a slab in accordance with some aspects of the present invention have drainage holes. Possibly, an exposed surface of the slab has a slope or curve to urge water and other liquids towards the drainage holes.

Possibly, in accordance with some aspects of the present invention a slab includes means for acoustic monitoring and/or moisture sensing and/or temperature monitoring and/or slab movement sensors. Typically, the sensors will allow remote monitoring of each or several slabs specifically or collectively. The sensors may be connected together or operated wirelessly. The slab may include a bonded earth tab. The slabs incorporate insulator slabs for acoustic attenuation as well as to fill gaps between slabs.

In accordance with some aspects of the present invention there may be provided with infill material below the slab to provide support and/or reduce sub-slab base degradation. The infill may provide self levelling for the slab. The infill may provide thermal and/or water penetration to the slab. The slab may include additional bolt holes for alignment in association with a clip.

In accordance with some aspects of the present invention there is provided lift slots in the slab. The slots may accommodate lift eyes. The slots may have a screw thread to accommodate the lift eyes.

Typically, the slab is 200 mm in thickness. The slabs are arranged to provide sliding rail connectors at the junction of juxtaposed slabs. Typically, in fill is provided between slabs. The in fill may be rubber. The slabs may accommodate fast charging rails embedded within the slab. Possibly, rails secured to the slabs may have inserts which can be removed. The rails may be removable by cutting, weld and reweld of the rail in use.

Possibly, the slabs may include solar panels. Possibly, the slabs may include means for accommodation of soil for plant growth such as grass. Possibly, the slab includes tunnels to allow wildlife to cross the slab. The slabs may include audible animal and/or trespass alarms. Possibly the slab includes apertures for location over service access holes.

Slabs may have a glued layer at ends, whether with convex to concave association or not, to provide separation between two slabs and/or stop or at least inhibit fretting occurring.

Possibly, the slabs may include or be arranged to combine with cant elements to present the slab at an angle particularly at curves and corners.

Also in accordance with aspects of the present invention the slabs may include passage panels to raise the surface above the slabs to be consistent with the rails for pedestrian passage. Alternatively, the slabs may include anti-trespass panels positioned between rails to prevent pedestrian or other passage. The anti-trespass panels may comprise spikes.

Embodiments of aspects of the present invention will now be described by way of example with reference to the accompanying drawings in which:

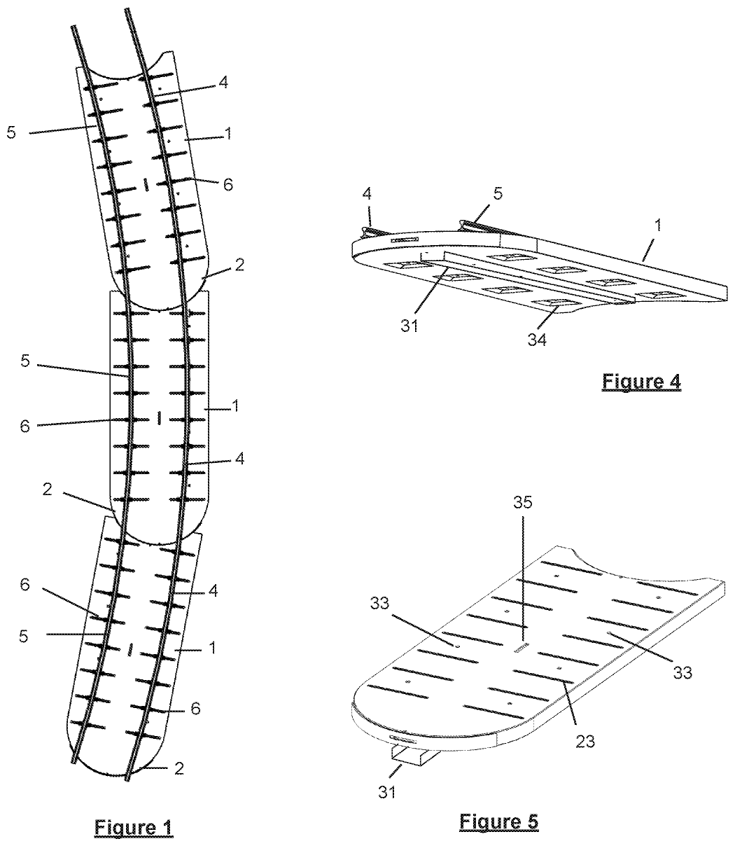

FIG. 1 is a schematic plan view of slabs for rail in accordance with aspects of the present invention;

FIG. 2 is a schematic front perspective view of a slab accordance with aspects of the present invention;

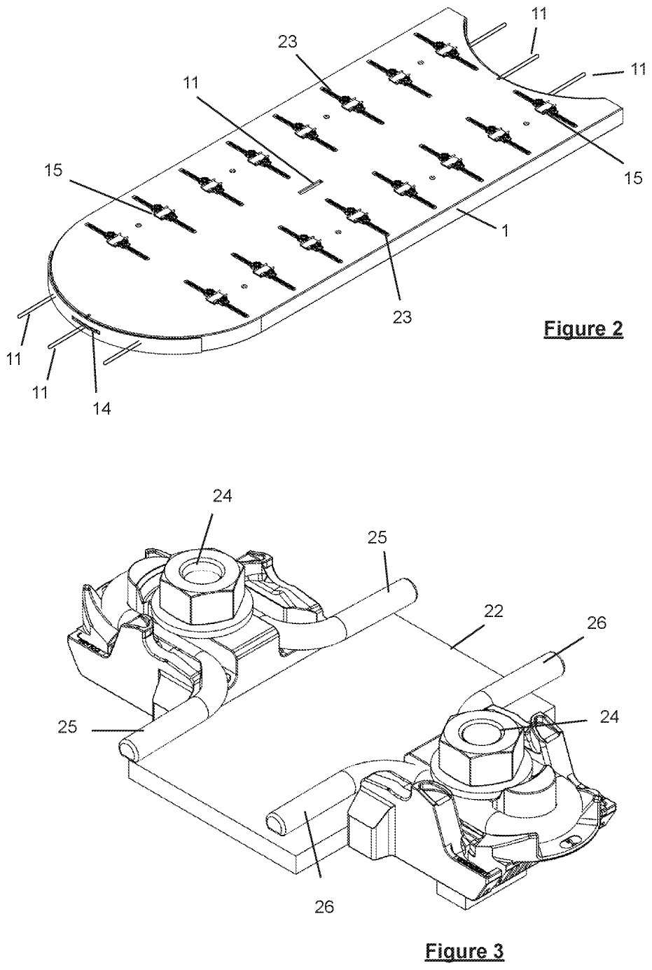

FIG. 3 is a schematic front side perspective of a clip for a slab accordance with aspects of the present invention;

FIG. 4 is a schematic bottom front perspective view of a slab where a utilities conduit can be located in accordance with aspects of the present invention;

FIG. 5 is a schematic top front perspective view of a slab as shown in FIG. 4;

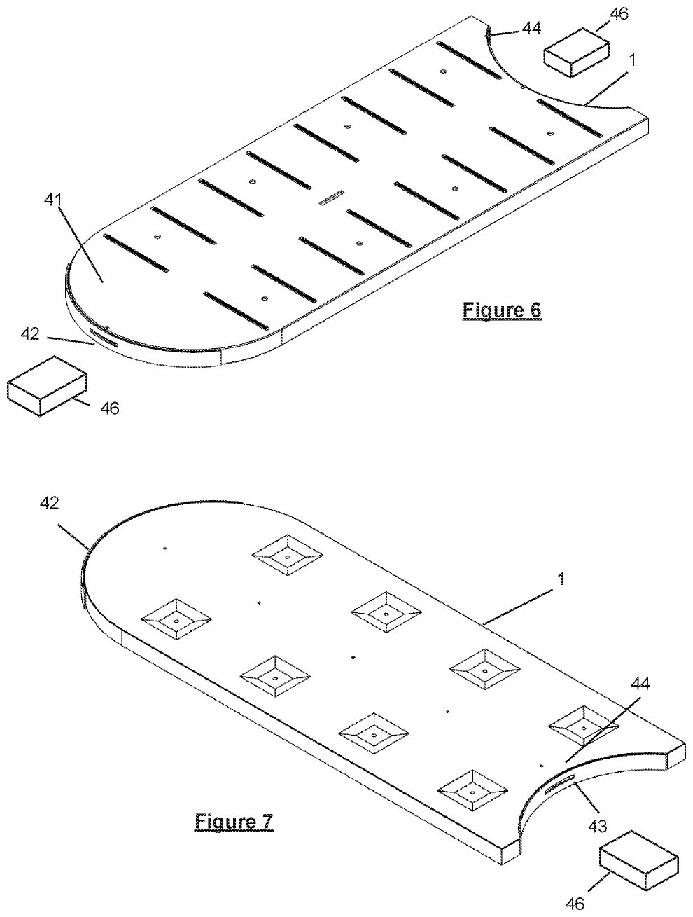

FIG. 6 is a schematic front top perspective view of a slab accordance with aspects of the present invention;

FIG. 7 is a schematic rear bottom perspective view of a slab accordance with aspects of the present invention;

FIG. 8 is a schematic rear perspective view of a slab accordance with aspects of the present invention with drain holes;

FIG. 9 is a schematic cross section of the slab depicted in FIG. 8;

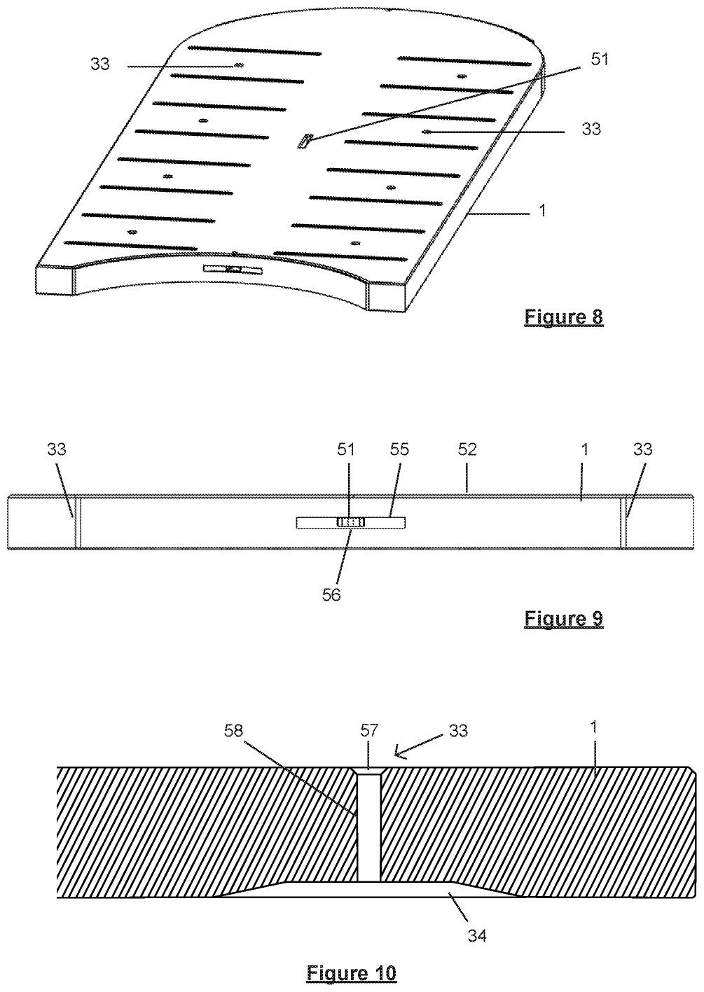

FIG. 10 is a schematic part cross section of a drain in a slab accordance with aspects of the present invention;

FIG. 11 is a schematic front perspective view of a clip for a slab accordance with aspects of the present invention;

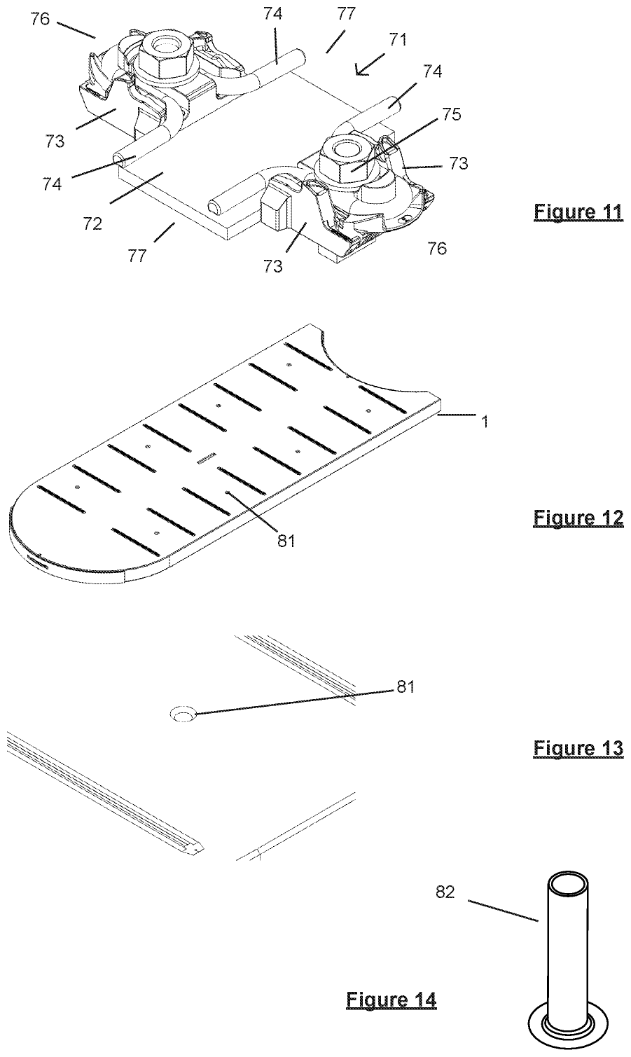

FIG. 12 is a schematic front perspective view of a slab accordance with aspects of the present invention;

FIG. 13 is a schematic illustration of a slot for a slab as depicted in FIG. 12;

FIG. 14 is a schematic perspective illustration of the insert peg for an slot as depicted in FIG. 12 and in FIG. 13;

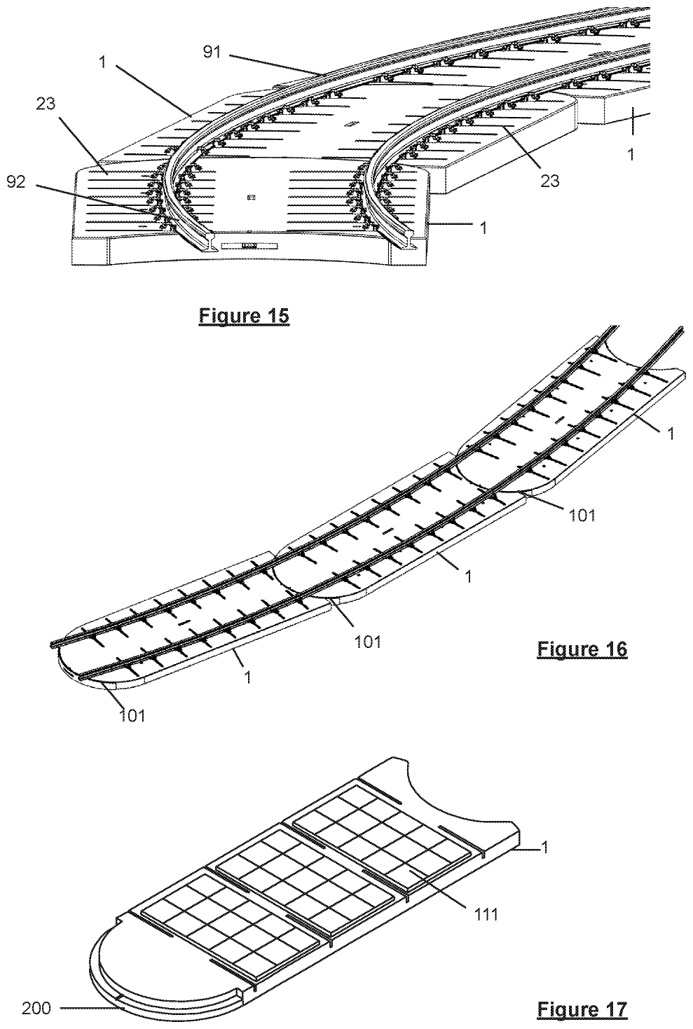

FIG. 15 is a schematic front perspective view of end of slabs accordance with aspects of the present invention;

FIG. 16 is a schematic top perspective view of several slabs accordance with aspects of the present invention;

FIG. 17 is a schematic top perspective view of a slab accordance with aspects of the present invention with solar panels;

FIG. 18 is a schematic top perspective view of a slab accordance with aspects of the present invention with indentations for soil;

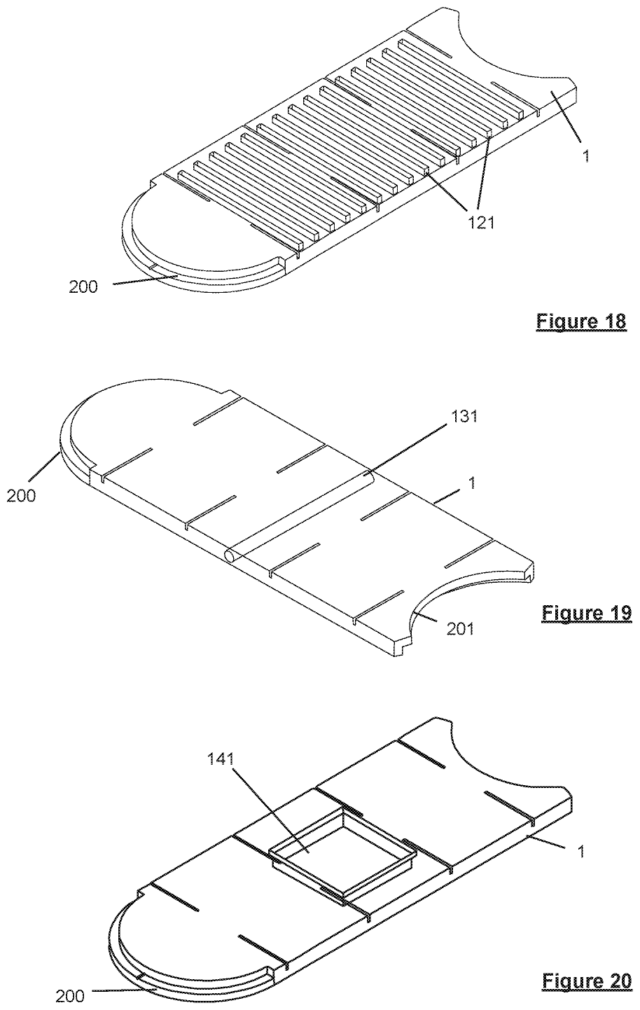

FIG. 19 is a schematic top perspective view of a slab accordance with aspects of the present invention with a wild animal tunnel; and,

FIG. 20 is a schematic top perspective view of a slab accordance with aspects of the present invention with a manhole aperture.

Provision of light railways or trams in a number of environments and in particular urban environments has a number of advantages in terms of cost effectiveness, congestion reduction, environmental emissions and convenience. Light railways need track rails and this can present one of the inhibitors to installation of such railway systems in urban environments not least in terms of the disruption during the installation stage. Previously, it has been known to provide slabs which can be placed in or possibly on an existing road surface. Although some foundations are needed it will be appreciated that light railways or trams by their nature do not require the necessary foundations for heavier duty railway systems. Slabs are most convenient when presented in a regular rectangular modular form so that rails, in parallel, can be fixed on their upper surface. However, in urban environments in particular, pre-existing features such as existing streets and buildings along with existing routes will mean that there is a need for turns and curves in the tracks and these will tend to be more abrupt and tighter curves than conventional rail track networks. In such circumstances either bespoke slabs are needed or a requirement for inserts which can present themselves installation and maintenance problems.

Provision of a slab for railways such as trams would ideally be configured for both straight and curved sections of track. FIG. 1 illustrates in plan view a plurality of slabs 1 with respective convex ends 2 and concave ends 3. These ends 2, 3 respectively engage similar ends 2,3 in adjacent slabs 1. The slabs 1 can be conventionally aligned straight (not shown) or angled relative to each other (shown in FIG. 1) such that a curved platform of slabs 1 is provided to receive rails 4, 5. No inserts are required between adjacent slabs 1 to achieve the necessary curvature in the presented rails 4, 5 held and secured by clips 6. It will be noted that the range of engagement is greater between the reciprocally concentric ends 2, 3 in comparison with prior normally straight ‘end to end’ abutment. This increases the potential for ‘gapping’ or discontinuity between the ends 2,3 at which wearing and erosion can occur according to conventional theory but as described below the present invention includes a primary as well as subsidiary features to mitigate and to enhance these features to relieve gapping problems. Furthermore, the present invention reduces the need for insert sections and other in fill elements which in their own right will create more junctions which may be subject to weathering along with wear and tear.

The slabs are generally 0.2 metres thick and formed of reinforced concrete.

The width of slabs is largely defined by the size of gauge (width) of the spacing between rails. Standard gauge is 1435 mm which is from rail interface to rail interface. This width must be maintained through all curvatures. Typically, the width of the slabs is 2600 mm, resulting in 582.5 mm of slab either side of the rails on straight sections however this will deviate when navigating corners.

It is possible to provide two pairs of track lines on one slab but logistically it would become complicated due to the weight and size of a suitable slab. A more practical approach might be to position and tie two separate slabs together laterally upon installation.

The reason for the different lengths of slab is to best accommodate different track curvatures that are required due to the rails following a smooth curve whilst the slabs are straight lengths. As described later the rails are secured with clips which are secured in slots formed in the slab.

There is a strong relationship between slab width and concave and convex diameters. To navigate corners most efficiently the diameter of the curved ends, is required to be the same as the width of the slab.

There are advantages in providing a ‘Lift and Shift’ slab system that enables the slabs to be quickly and efficiently lifted as individual panels to enable ease of access to utilities below. In such circumstances providing regular modular slab sizes and shapes with consistent convex and concave ends is advantageous in that if one slab should need to be replaced for whatever reason replacement slabs will be pre-formed and can be retained at a suitable maintenance depot.

In accordance with second aspects of the present invention there is provided as illustrated in FIG. 2 a slab 1 typically similar to that shown in FIG. 1 in which there is an embedded optical fibre or fibres 11. The fibre or fibres 11 typically pass through the centre 14 of the slab 1 or under the rail fixings 15. The fibres 11 may carry different frequencies to determine and identified different failure modes for the slab. Furthermore, a sensor may be used with the optical fibres 11 to determine different vibration signature frequencies indicative a rail event such as passage of a tram or a cracked/distorted rail.

It will be appreciated that rail infrastructure is currently manually inspected in a scheduled programme, but it is also known that inspections may be skipped due to time restraints/in advertently or a failure is not identified meaning that there can be delays or even fatalities if the failure proves to be catastrophic. The use of optical fibres 11 in the centre or otherwise across the slab allows slab lengths to be autonomously and individually monitored to identify failure points and at least monitor and identify stab movement, instability and cracking. Such monitoring can use known vibration signature frequencies. It will be understood that the optical fibres 11 will at least be distorted by movement as a train passes along the rails presented by the slabs 1 which will alter the frequency response along the optical fibres 11. This will determine movement and of course fracture or permanent bending/distortion of the optical fibres will also indicate a failure or damage at a slab 1.

In accordance with third aspect of the present invention slabs as described previously have clips 22 for rails mounted above and in a transverse slot 23 (see FIG. 2) formed within the slab to allow movement which in turn allows for positioning of rails on the slabs. Traditional precast slab track rail infrastructure requires the rail connection fixings to be embedded/moulded into the exact correct position requiring jigs and measuring during the manufacturing process. This is time consuming and requires relatively highly skilled labour. Using bolts and nuts 24 to secure the clip 22 in a lateral slot embedded into the concrete of a slab in accordance with aspects of the present invention, allows for a fixing bracket or clip 22 position to be adjusted into the exact position required both in the X and Z axis for location of a rail. The clip 22 can move laterally along the range of the slot 23. This solves the issue of difficulties with aligning rails when either navigating slight changes in direction or corners. Additionally, it also enables different size gauges (spacing of rails) to be created without any specific changes to the pre-formed slab or fixings themselves just movement of the clip 22 fixing and securing with bolts and nuts 24 at the new location. The slot 23 as illustrated in FIG. 2 extends from an edge, or near to, inward and normally perpendicular to an edge of a slab such that a clip 22 can move along the slot 23 in a lateral direction with in the slot 23 for a new lateral position. The slots 23 are normally evenly distributed along the length of the slab 1. It will also be understood that by use of bolts 23 in the slots that each clip 22 is secured and that the ‘height’ of the clip 22 and so the rail can be adjusted against a spacer (not shown). The rail will be positioned between guides 25, 26 with fastenings into apertures but more normally to lateral flanges of a generally T or I cross-section rail (not shown).

Conventional previous fixing methods involved a rail fixing either being precast into the concrete, or the holes that are required for fixings being drilled into the concrete. By making the slot 23 a lateral recessed groove along with typically an embedded reinforcing steel insert encased into the concrete of the slab, the slot 23 as lateral groove can receive a T head of a bolt in the slot 23 which can be slide to necessary position to secure a rail and then can be secured with the nut 24. The T head can be slide from an open end of the slot 23 or design to be a T bar which can enter the slot 23 then be turned 90 degree so that the T bar engages the slot 23. This avoids the need for accurate pre-casting of the fixing itself or drilling of holes whilst it provides a strong connection between slot and fixing bracket/clip 22. This also means that jigs and measurements to ensure the fixing are moulded in the correct position are not required, and that no additional time is required to drill multiple holes in the concrete for fixings to be attached.

Utilities such as electrical and communications cables are nearly always found below ground in urban areas. When a new rail track system is installed the track system is installed above these utilities. This is acceptable until the utilities below need to be accessed for maintenance, repair or renewal. Using a concrete U-shaped channel positioned under the slab, the utility cables are contained tidily all in one place within the channel and with acceptable accessibility as described below by lifting the slab and/or access manholes. Additionally, a cut away can be provided on the underside of the slab that provides additional room for conduits and services if required. This removes the need for the concrete slab to be broken up or dug up to achieve access. It also reduces the length of downtime and also is a more cost effective solution as the original slab can be replaced with a new pre fabricated slab if required as a relatively simple and easy swap. Whilst also enabling easier access for repairs of utilities as they are not buried in soil, ballast and sand. FIG. 4 and FIG. 5 provide respectively a perspective view of a slab 1 with rails 4, 5 above and a space 31 below for a channel which is typically a rectangular U shape in cross section below it. The channel 31 provides a conduit for utility cables which can be accessed as discussed by lifting the slab 1 or via access manholes or hatches (not shown). The hatches will be secured and/or the cables anchored to avoid theft and/or vandalism. The channel 31 will generally be central within the slab 1 to that drainable holes 33 are avoided along with recesses 34 to disperse drainage water through the holes 33. A lifting recess 35 for the slab may also be provided.

Steel reinforced concrete is heavy. Concrete also has a high carbon footprint. Freezing and thawing (thermal loads) can damage traditional concrete. The slabs in accordance with the present invention may be formed from a speciality concrete such as Tritonite (RTM). Such slabs are lighter using the reinforcing fibres as compared with steel reinforcement. Reinforcement fibres can be polypropylene sticks which may provide a 70% reduced carbon footprint for the slab. Fibres provide strength throughout the slab whilst providing enough plasticity to withstand temperature changes, stressing and shocks to the slab.

As indicated above slabs in accordance with aspects of the present invention may have a uniform shape of slab. Only ‘straights’ sections are required having respective concave and convex ends to achieve curves and corners by combinations. It will be understood as shown in FIG. 1 these slabs 1 are laid linearly and in series from a start point to an end of a spur. It may be possible to simultaneously lay slabs for each spur' Speciality slabs for junctions of two rail spurs can be provided. Also, if needed slabs with two concave ends to join two linearly laid spurs of rail sections towards each other can be joined with the two concave ends. In such circumstances the approaching convex ends can be accommodated or vice versa to spurs of as laid diverging rail slabs so the two convex ends engage the concave end of the first slabs of these diverging laid rail slab spurs. These slabs can be specifically moulded or probably more advantageously created by cutting and combining the two ‘uniform’ slabs cut to the correct length and orientation. The concave/convex ends allow the slabs to be positioned immediately following each other at an angle which reflects the rail curve.

Rails have varying curvatures at bends and curves. The curve of a length of one rail may extend beyond the width or length of one slab. Rails can extending beyond the width of the slab as the slab sections are all straight and provide a platform for the rails so matching of slab length and rails is not required and in some circumstances might be advantages in keying rail and slab sections together. The rails are cut or infilled with rail sections then welded into place. However, although a uniform slab is desired it will also be understood with mutually coherent ends (convex and concave) that slabs of different length may be provided. Reduced length of slab allows for more accurate and tighter angle curves to be laid to more closely match that of the rail curvature required.

Copper or any other suitable conducting loops can be embedded into the slabs or below them. Copper or other material charging loops along the rail line will enable fast charging coils to be embedded within a slab. A train is required to be operational throughout its service each day. The range of a train inevitably depends on the stored and carried batteries on the train. These batteries may not be enough for a desired service period hence to possible need to use IC engines or hybrid operation. The use of fast charging coils allow use of smaller and/or lower capacity batteries or extend the accepted operation service period. Furthermore, such charging and so lighter lowe capacity batteries may significantly reduce train weight which means less propulsive power is required, less wear and tear on the rail network and reduced force necessary for braking etc. Wireless coils pass electrical current by induction from the coils in or below the slab and into the train as it passes over or is stationary at a stop. The current is exchanged between two coil sets, one in or below the slab and the other in the train. Wireless charging allows the vehicle to run without having to stop at a depot and charge for long periods of time out of service. Reducing the total number of train vehicles required to work on a line in a network.

As will be appreciated proper alignment of slabs during installation is important so aspects of the present invention use engagemant at joints to enable alignment between the convex and concave ends. Precast concrete slabs will always move and rotate as forces are applied to them in different directions. As used in a rail application it is imperative that the slabs stay as aligned as possible in all axes and within certain tolerances. With the use of an overlapping or butt joint, the two faces engaging end faces can also have an elastomer between the two to ensure a constant contact throughout the aligned connection between slabs. This will also reduce and stops the twisting rotation of the slabs about the junction of the adjacent slabs that could occur when rail and road vehicles pass over the top of it. FIG. 6 and FIG. 7 illustrate respectively front above and end below perspective views of a slab 1 in which at the front convex end 41 a groove or recess 42 is provided which in use will engage with a reciprocal recess 43 in the concave end 44. The recesses 42, 43 align and position the slabs. Normally an elastomeric or similar filler is provided between the ends 41, 42 in use to provide a barrier to inhibit water ingress at the intersection between slabs 1. The grooves or recesses 42, 43 provided as depicted in FIG. 6 and FIG. 7 a recess for tongue or alignment members 46. These members 46 could be integrally formed with the slabs but may then suffer from facture and damage of the extended tongue part at least. Advantageously, the slots or grooves 42, 43 in the ends 42, 44 of the slabs could be simply formed and a separate tongue or alignment element 46 provided such as a resilient steel or similar bar insert to span the opposed slots or grooves 42, 43 for alignment of the slabs 1 in use.

Slabs in accordance with aspects of the present invention create a surface which will restrict drainage and soak away. In urban areas, non-permeable pedestrian walkways and road surfaces are non-permeable and therefore large amounts of surface run off water is not able to permeate through the top surface and so increases the risk of flooding Thus, in accordance with aspects of the present invention drainage holes and an angled top face into a centre towards the drain holes are provided in the slab for water run off. The angled top surface to the slabs encourages surface rain and other water run off to the centre where drain holes are provided. The drain holes connect to drains so that water then flows down the drains positioned along the lengths of the slab. This approach reduces the risk of flooding in urban areas where there is a high proportion of non-permeable surfaces. FIG. 8 provides a top perspective view of a slab 1 with central drainage hole 51 and spaced drainage holes 33 (also seen FIG. 5). FIG. 9 a cross-section of the slab 1 illustrating the central drainage hole 51 with a top surface 52 which may be down towards the hole 51. The hole 51 may also provide means for lifting the slab 1 and a passage 55 provide ducting for utilities 56. These drain holes 51, 33 may lead to a sump but more importantly to storm drains to disperse water rapidly. FIG. 10 illustrates a drain hole 33 cross-section in a slab 1. The hole 33 has an exposed aperture 57 which extends into a passage 58 and then an outlet side in a recess 34 (see FIG. 5 as well). The purpose of the drain holes 33, 51 is to remove efficiently rain water on the slab 1 which provides a platform for the rails.

Acoustic condition monitoring can be provided as a train passes over the slab. Acoustic monitoring allows the condition of the slab to be monitored remotely. The rails over time also experience wear from the repeated strain. Audio signatures can be measured by a sensor and the results monitored to listen for issues.

Subsidence, expansion and shrinking of soil below the slabs can have a detrimental effect on the stability of the slabs that sit on top of it. These effects can cause misalignment, twisting and separation of the slabs whilst the tracks could have additional strain applied to them. Remote autonomous moisture sensing can be achieved through the use of sensors positioned in vertical tubes below the slabs, the moisture content/water levels are continually monitored. By remotely and autonomously sensing the moisture it reduces the risk of failure and enables preventative measures to be put in place such as reducing train speeds.

Temperature can affect the condition of concrete via ‘thermal loading’. Thermal loading can result in ‘hogging’, where the slab contorts the edges up and down as the concrete expands and contracts. High thermal load may result in cracking of the concrete. Rail track suffers from temperature changes resulting in expansion and contraction, this creates ‘buckling’ and can render the track unsafe. Remote autonomous slab and track temperature sensing can be provided such that the temperature of the slab and rail is monitored locally. The temperature is measured against FEA data or previous temp data which indicates a safe condition of the slab/track. By understanding thermal loading the condition of the rail line can be better understood by maintenance crews. This reduces the need for manual inspection. Understanding the thermal loading on the rail provides real time data on the condition of the track regarding potential buckling, again reducing the need to manually inspect for buckling.

Concrete slabs and track may move due to repeat stress from the train passing. Movement may result in misalignment of the tracks, causing wear to the train, excess stress on the slab or other factors. Movement of slabs may result in track instability and instability of the bed. Remote autonomous slab and track movement sensing is provided by sensors which register vibration and movement. The data is parsed through software which determines if there is an issue with the track or slab.

Movement data also correlates with moisture data, revealing if there is subsidence or similar. Monitoring of slab and track movement provides essential condition information that crews can use to determine if a manual inspection is necessary. Or, if a sudden catastrophic event is likely to occur. This information is given to maintenance crews in real time, with weather predictions mixed in to inform operators of future temperatures.

Wireless charging, monitoring equipment and charge rails all require power. Good continuity is essential for this equipment to work. By each slab being electrically enabled they can be strung together to enable electrical continuity monitoring. Wireless charging, monitoring equipment and charge rails all require power. Good continuity is essential for this equipment to work. Resistance testing is applied to each slab. This indicates the quality of the electrical connection. Poor connection may indicate wear or loose connections, which may result in short circuits. Continuity monitoring allows maintenance teams to see the connection quality of all electrical equipment, improving the lifespan and functionality of the respective piece of equipment.

There are various features which require that the train communicates with the track to allow power to circulate only where the train is, preventing Injury to pedestrians who may touch the line. Earth bonding creates a safe passage for current to flow. This prevents current flowing into someone who might be touching the line, or for the train body to hold charge itself. Earth bonding allows the slab below the train to be switched on and off while allowing power to safely flow along the line of slabs. This capability allows induction charging, location correlation and third rail charging to be deployed.

Slabs in accordance with the present invention can have Injected fill material used below the slab to support weight and reduce of sub-base degradation. Furthermore, self-leveling material can be used to create a base for slab installation and insulating material to prevent freeze and thaw impacts on the slabs. Sub-base materials are typically not perfectly level. This results in high and low points which creates voids. Concrete can suffer from freezing and thawing activity. The Injected material below the slab will level the base material, eliminating the voids and spreading the slab weight more evenly. Injected material also insulates the slab from rapid ground temperature changes, reducing the impact of freeze thawing. It solves the issues that voids can create. The high spots create high pressure areas which when the train passes over, cause cracking. FIG. 10 shows a part cross section of a slab 1 illustrating drain holes 57 but these can also act as injection holes for a filler. Thus, some holes might be drains and some injection holes. The holes and passages 58 may be 15 mm in diameter such that infill can be pumped below the slab 1.

Using a straight shaped slab to create a curve it will be understood that rail position will vary lateral on each platform and so the rail curves away from the centre of the slab. Casting the clips to match the radii of an existing rail curve may prove unreliable and slow the manufacturing process. Aspects of the present invention provide a rail clip with extra bolt holes for rapid alignment in use. Extra bolt holes allow a standard bolt to fix to a rectangular threaded plate located in a slot below. The bolts are tightened to secure the clip in place. This clip placement can be adjusted quickly and easily upon installation of the rail. The extra bolts (or, a clip baseplate with fastening mounts in the correct location) provide a quick and easy way to align the clip to the rail curve profile in relation to the slab. FIG. 11 shows a clip 71 for bolt holes for a bolt 75 so the clip 71 can be fixed in a slot of the slab (not shown in FIG. 11 but shown as slots 23 in FIG. 2) to vary its position and so where a rail is fixed. The clip 71 sits in the line 76 which in use is generally perpendicular to a rail which sits in the direction of line 77. The clip has a plate 72 with respective flange portions 73 and then retainers 74 held by the bolts and nuts 75. The retainers 74 have retainer fingers which extend above the plate 72 so that the flange portions of a typical rail cross-section is securely fixed between the retainer fingers and the top of the plate 72.

It will be appreciated that slabs in accordance with aspect of the present invention will have significant mass. Thus, lift slots and/or eyes can be provided to lift the slab in use and installation/de-installation. Precast slabs of concrete are large, very heavy and cumbersome to move with a weight of around 7 tonnes for a 6-meter length of slab. By using a length of tube with an internal thread that is embedded into the slab concrete, eye bolt hooks can be attached or detached when the slabs are being installed, adjusted or uninstalled. This solves difficulties when initially lifting and installing the slabs, along with the situation if slabs are required to be lifted at a later date for maintenance work, or for utilities below to be worked on. Furthermore, where the slabs have a lip, a shelf and a ledge or tongues and grooves/slots convex and concave ends the lift slots will allow the slab to be tilted out of engagement by lifting one end of the slab up at an angle and withdrawal laterally/longitudinally. FIG. 12 shows a slab 1 with slots 81 (FIG. 13) which can also act as drainage holes as described previously but also in accordance with this aspect of the invention act as lifting anchor points particularly if reinforcing sleeves 82 (FIG. 14) are embedded or secured in the slot 81. The sleeves have screw threads in which a lifting eye (not shown) can be secured to lift the slab 1. As shown in FIG. 13 the slot or hole 81 is rounded and generally chamfered to limit stressing when used in a lifting process. A central slot 82 can also be provided and dual purposed to lifting too.

Large amounts of concrete are used for the manufacture of prior slabs as slabs particularly as the same slabs are commonly used for heavy rail applications as opposed to light rail applications. Use of comparatively very light train vehicles driving over the slab in accordance with aspects of the present invention mean the slab can be a lot shallower and therefore use a lot less concrete. Slabs can be as thin as 20 centimetres. Furthermore, concrete manufacture has a high carbon footprint so a reduced slab thickness will significantly reduce the carbon footprint and environmental impact of slabs in accordance with aspects of the present invention. Some of this is embodied in the transport of the materials and the delivery of the pre-cast elements. Utilising local manufacturing facilities built on the site of the railway, or at central regions with materials within the same region will reduce the carbon footprint of delivery. Low carbon footprint supply chains reduce the impact of manufacture and delivery of pre-cast concrete modular slabs.

In some embodiments there may be advantages with adaptable gauge adjustment. By having sliding rail connectors, the width spacing of the rails can be easily increased and decreased. Different gauge wheel widths of different trains resulting in only some trains being able to operate on certain track infrastructure. Rail vehicles with different wheel gauges could all use the same line, or when a train is purchased it doesn't have to be specific to the track gauge originally installed. With a slot and clip slidable in the slot laterally the gauge can be relatively quickly altered. FIG. 15 provides a schematic illustration of slabs 1 associated together in accordance with aspects of the present invention. Rails 91 extend over the slabs with adaptable gauge adjusters 92 comprising the clips or fixings 22, 71 described above in lateral slots 23. The adjusters 92 move with the slots 23 to allow the rails 91 bent by appropriate means to create a curve. It will be noted that the slabs 1 define an arc to create a platform to present and support the rails 91. The adjusters 92 in the form of clips 22, 71 and retainer bolts are not at a fixed displacement along all the slots 23 in a slab 1 as would be the situation with a straight section of track so the use of a lateral slot 23 range avoids the need for accurate fixing points in the slabs.

Rubber in-fill is provided between slabs in accordance with aspects of the present invention. Rubber in-fills prevent water entering the sub-base from above and also prevents growth of plants between slabs. Fine alignment of the slabs is then not imperative so reducing cost and time of installation. In such circumstances, water ingress into sub-base is reduced with filling of the gap between slabs. Water ingress into the sub-base below the slab can flush sub-base foundation materials away and lead to destabilisation. The gap between slabs may leave space for unwanted vegetation to grow and fine alignment of slab may be difficult due to the weight of the slab. Infill increases allowable tolerances between slabs. FIG. 16 provides a schematic perspective view of slabs in accordance with aspects of the present invention with infill 101 between them. These rubber in-fills may also reduce acoustic noise with regard to rail vehicles passing along the rails. The infill may be injected or otherwise forced in to the near abutment between front and rear ends of the slabs 1 or the infill 101 can be a strip of material secured at least one end of each slab 1.

Provision of the capacity for fast charging rails to be embedded within the slab or below them would be advantageous. This may be achieved by having a recess to enable the charging rails to be mounted within recess and so the slab. Charging of an electric train is required to keep it operational. There are no prior solutions to enable flash charging of a train using a precast slab infrastructure. Flash charging rails are always used on segregated railway infrastructure as opposed to inner city open infrastructure, due to the raised rail heights that would be needed which means that road vehicles cannot drive over them.

Aspects of the present invention provide spaces to cut the rail, weld and reweld it as is required. Open rail infrastructure usually involves the rails being embedded in elastomer making it hard to cut or reweld the track. The current process is messy and time consuming and is not as efficient as it really could be. Some aspects of the present invention address this problem by having areas that are not filled with elastomer and are instead filled with an insert that can simply be removed, and then replaced after works are carried out. The difficulty of having to scrape away the elastomer to cut or weld joints is thus avoided.

Aspects of the present invention provide solar panels that can be integrated into the modular slabs. Solar cells are installed on the top of the slabs to generate electricity that is either used to power the trains and any surplus is sold back to the electrical power grid. It will be appreciated that an electric very light rail vehicle uses a considerable amount of electrical power to enable them to move and so generation of at least some of that electricity will reduce the costs of operating the vehicles. This is achieved by generation along the track as opposed to solely drawing electricity from the national electrical power grid with its inherent transmission losses and this will in turn reduce the cost of charging the train. FIG. 17 shows a slab 1 with solar panels 111 located upon them.

Aspects of the present invention allow the use of so called grasscrete. In urban areas, where non permeable materials are used there can be created higher levels of surface water runoff and also reductions in the amount of biodiversity of habit for plants, insects and animals available. By having moulded concave strips this enables these areas to be filled with soil and then planted creating a natural habit for insects along with acting as a soak away for surface runoff water. This solves the problem of lack of biodiversity habitats and also acts as an area for excess surface water absorption/runoff. FIG. 18 illustrates a slab 1 with moulded concave strips 121 to receive soil.

Aspects of the present invention can provide an audio animal deterrent. An audio tune is played approximately 100-200 m before a train as a warning to inform mammals and other wildlife of the oncoming train encouraging them to move off the line. Infrastructure commonly does not accommodate for the wildlife that lives around it, therefore there are a number of trackside animal fatalities which could be avoided. Similarly, provision of an audio pedestrian trespass deterrent can be provided. An audio tune is played approximately 100-200 m before a train as a warning tone to inform pedestrians of the oncoming train. People either trespassing on the line or working on the line are at risk of being hit by an oncoming train if not warned. In addition, in order to encourage crossing of the track rails at specific positions, crossing panels can be added to raise the surface at such crossings either side of the rails to that substantially consistent with the top of the rails. Thus, pedestrians would not need to step over the rails. Alternatively, anti-trespass panels could be provided to discourage crossing at particularly dangerous locations. These panels may comprise spikes either side of the rails will inhibit walking by pedestrians but allow the tram to move over and along the rails.

It will also be appreciated that a safe means for animals such as small mammals to cross the tracks can be more conveniently provided with modular slabs in accordance with aspects of the present invention. Rail infrastructure commonly does not accommodate for the wildlife that lives around it, therefore there are commonly trackside animal fatalities that could be avoided. As illustrated in FIG. 19 a tunnel 131 in a slab 1 provides a passage for the small animals, frogs etc. that wish to cross the slab 1 and so the rails. Thus, although small animals have no way of passage over or under a slab they can pass through it.

In some embodiments a shelf or lip can be provided at the ends of the slabs and more typically along the curved (convex and concave) ends may include inter-engaging with each other in opposed ends to facilitate alignment and location in use.

FIGS. 17 to 20 show such shelf or lip ends 200, 201. It will be understood in use the lips 200 and shelves 201 in a line of slabs 1 will sit one upon the other typically with a sealant between them. Slabs may be presented on vibration pads to reduce acoustic noise as well as vibration of the slabs as a vehicle passes over the slab on rails or a road vehicle. Furthermore, slabs in accordance with aspects of the present invention may incorporate a charging rail, at least around stations, to provide for charging and in particularly rapid charging of vehicle batteries.

Use of slabs in accordance with aspects of the present invention allow use of banking elements and/or ground works foundations so that the rails are presented at an angle or cant to the horizontal at curves and/or corners so that vehicles can turn at higher speeds more easily achieved such as a 75 metre radius and speeds up to 30 miles per hour. This may have particular advantages in the tighter environs within an urban railway system.

Aspects of the present invention provide for manhole covers to access utilities below e slabs. When a precast slab is installed and placed over utilities situated below it can be difficult to access, alter or modify the utilities below. An access hole is positioned in the centre of the slab and allows for cables to be accessed and managed below. This approach solves the problem and difficulties of no access to utilities without moving the entire length of the slab which can be time consuming and costly. FIG. 20 shows a schematic front perspective view of a slab 1 with manhole 141 which can provide access to a pre-existing man hole below the slab 1 or to a utility/service conduit below the slab.

1. A track slab comprising a plurality of juxtaposed slab elements with a least one rail extending over those slabs, the slabs having opposed convex end and concave end in respective ends for inter-engaging of adjacent slabs whereby the slab elements are configured to be positioned substantially in the plane of the inter-engaging convex end and concave end whereby the longitudinal axis of each slab need not be parallel or aligned with adjacent slabs.

2. A track slab for rails, the slab comprising an elongate element with a convex end and a concave end to allow articulation thereabout.

3. A track slab as claimed in claim 1 or claim 2 wherein a the track slabs are provided so that the convex end and the concave end re reciprocally shaped for inter-engaging with adjacent slabs in use.

4. A track slab as claimed in any of claims 1 to 3 in which the slab includes at least one optical fibre and preferably at least 3 optical fibres arrange to allow coupling with other optical fibres.

5. A track slab as claimed in any preceding claim wherein the slab has a slot lateral from an edge and arranged to receive a clip such that the clip for a rail can be positioned along the slot.

6. A track slab as claimed in any preceding claim wherein a slab with a longitudinal recess along the slab configured to provide accommodation for transit of service and other conduits.

7. A track slab as claimed in any preceding claim wherein the slab is formed with fibres for reinforcement.

8. A track slab as claimed in any preceding claim wherein the slab can have a plurality of lengths whereby a range of curves in conjoined juxtaposed slabs can be achieved.

9. A track slab as claimed in any preceding claim wherein the slab is provided with charging loops embedded within the slab.

10. A track slab as claimed in any preceding claim wherein the slab has a lip or shelf or ledge element or tongue and groove/slot at the convex and concave ends to align the slab with other juxtaposed slabs in use.

11. A track slab as claimed in any preceding claim wherein the slab has drainage holes and an exposed surface of the slab has a slope or curve to urge water and other liquids towards the drainage holes.

12. A track slab as claimed in any preceding claim wherein the slab includes means for acoustic monitoring and/or moisture sensing and/or temperature monitoring and/or slab movement sensors.

13. A track slab as claimed in any preceding claim wherein infill material is provided below the slab to provide support and/or reduce sub-slab base degradation.

14. A track slab as claimed in any preceding claim wherein there is provided lift slots in the slab.

15. A track slab as claimed in any preceding claim wherein the slab is 200 mm in thickness.

16. A track slab as claimed in any preceding claim wherein the slab includes solar panels.

17. A track slab as claimed in any preceding claim wherein the slab includes means for accommodation of soil for plant growth such as grass.

18. A track slab as claimed in any preceding claim wherein the slab includes tunnels to allow wildlife to cross the slab.

19. A track slab as claimed in any preceding claim wherein the slab includes audible animal and/or trespass alarms.

20. A track slab as claimed in any preceding claim wherein the slab includes an aperture for location over service access holes.
